(19) United States
(12) Patent Application Publication
(10) Pub. No.: US 2016/0239669 A1
(43) Pub. Date: Aug. 18, 2016

(54) User Terminal And Method For Protecting Core Codes Of Applications Using The Same

(71) Applicant: Soongsil University Research Consortium Techno-Park, Seoul (KR)

(72) Inventors: Jeong-Hyun Yi, Seongnam-si (KR); Sung-Ryoung Kim, Seoul (KR)

(73) Assignee: Soongsil University Research Consortium Techno-Park, Seoul (KR)

(21) Appl. No.: 14/784,292

(22) PCT Filed: Mar. 6, 2015
(86) PCT No.: PCT/KR2015/002202

§ 371 Date: Apr. 26, 2016

(30) Foreign Application Priority Data
Oct. 21, 2014 (KR) 10-2014-0142293
Jan. 8, 2015 (KR) 10-2015-0002937

(51) Int. Cl. G06F 21/60; G06F 21/62

(52) U.S. Cl. CPC G06F 21/602; G06F 21/6209

(57) ABSTRACT

A user terminal includes a communication circuit, an encryption-decryption circuit, and an execution circuit. The communication circuit receives a core code file of an application from a peripheral device, which stores the core code file of the application, when certifying a core code of the application. The encryption-decryption circuit encrypts the core code file and transmits the encrypted core code file to the peripheral device, and, when executing the application, receives the encrypted core code file from the peripheral device and decrypts the encrypted core code file. The execution circuit executes the application using the decrypted core code file and a normal code file of the application stored in the user terminal. Since the normal code file is stored in the user terminal and the core code file is stored in the peripheral device, the core code of the application is protected from reverse engineering attacks.

### THE ART TO WHICH THE INVENTIVE CONCEPT

Example embodiments generally relate to user terminals and methods for protecting core codes of applications using the same, and more particularly relate to user terminals that are able to protect core codes of applications from reverse engineering attacks and methods for protecting core codes of applications using the user terminals.

### BACKGROUND OF THE INVENTIVE CONCEPT

Smart phone users are able to receive various kinds of services by downloading applications and contents, which are developed by a third party, from digital open markets, such as Google Play, and executing the applications. As a result, a lot of data are stored in a smart phone. Sensitive data or secure data may also be stored in a smart phone, such that security technologies have been developed to protect the sensitive data or the secure data.

Data, which include financial information, personal information, etc., stored in a smart phone may be leaked by a tampered application as well as by phishing, pharming, smishing, etc. Attackers extract a decompiled source code by performing a reverse engineering on an application and generate a tampered application by inserting a malicious code in the decompiled source code. Sometimes, attackers get economic benefit by illegally using the decompiled source code.

Particularly, compared to iphone applications, Android applications are easily analyzed to extract a decompiled source code from the application, such that Android applications are targeted by hackers to generate a tampered application.

Various kinds of source code obfuscate technologies and LVL (Licensing Verification Library) of Google, which increase time for analyzing an application or make it difficult to perform a reverse engineering, have been developed to prevent illegal copy of an application and application tampering.

However, technologies that make it impossible to extract a decompiled source code from an application or make it impossible to analyze an application are required to basically protect an application and user information.

The background art of the present invention has been described in Korean Patent Registration Publication No. 10-1328012 (2013. 11. 13).

### CONTENT OF THE INVENTIVE CONCEPT

### Technical Object of the Inventive Concept

Some example embodiments of the inventive concept provide a user terminal that is able to protect core codes of an application from reverse engineering attacks and a method for protecting core codes of an application using the user terminal.

### Means for Achieving the Technical Object

According to example embodiments, a user terminal for protecting a core code of an application includes a communication circuit, an encryption-decryption circuit, and an execution circuit. The communication circuit receives a core code file of the application from a peripheral device, which stores the core code file of the application, when certifying the core code of the application. The encryption-decryption circuit encrypts the core code file and transmits the encrypted core code file to the peripheral device, and, when executing the application, receives the encrypted core code file from the peripheral device and decrypts the encrypted core code file. The execution circuit executes the application using the decrypted core code file and a normal code file of the application stored in the user terminal.

The encryption-decryption circuit may encrypt the core code file using distinct information of the user terminal and decrypt the encrypted core code file using the distinct information of the user terminal. The distinct information of the user terminal may include at least one of an international mobile equipment identity (IMEI), an Android Identification (ANDROID_ID), a serial number, a phone number, a model number, and a media access control (MAC) address.

The peripheral device may receive the core code file from an application providing server and store the core code file. The application providing server may generate the core code file and the normal code file by dividing an installation file of the application into the core code and a normal code, transmit the core code file to the peripheral device, and transmit the normal code file to the user terminal.

The core code file may be selected by at least one of a user and a function or an object predetermined by a platform of the application providing server.

In a method for protecting a core code of an application installed in a user terminal, the user terminal receives a core code file of the application from a peripheral device, which stores the core code file of the application, when certifying the core code of the application, encrypts the core code file to transmit the encrypted core code file to the peripheral device, receives, when executing the application, the encrypted core code file from the peripheral device to decrypt the encrypted core code file, and executes the application using the decrypted core code file and a normal code file of the application stored in the user terminal.

### Effects of the Inventive Concept

Since the normal code file is stored in the user terminal and the core code file is stored in the peripheral device, which is able to communicate with the user terminal, the core code of the application is protected from reverse engineering attacks.

In addition, the user terminal encrypts the core code file using the distinct information of the user terminal, and the peripheral device stores the encrypted core code file. Therefore, although one of the user terminal and the peripheral device is stolen, the acquirer can not be able to execute the application. As such, an illegal use of the application is effectively prevented.

### BRIEF DESCRIPTION OF THE DRAWINGS

FIG. 1 is a diagram illustrating a system for protecting a core code of an application according to example embodiments.

FIG. 2 is a block diagram illustrating a user terminal according to example embodiments.

FIG. 3 is a block diagram illustrating a peripheral device according to example embodiments.

FIG. 4 is a flow chart illustrating a method for protecting a core code of an application according to example embodiments.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

Hereinafter, various example embodiments will be described fully with reference to the accompanying drawings.

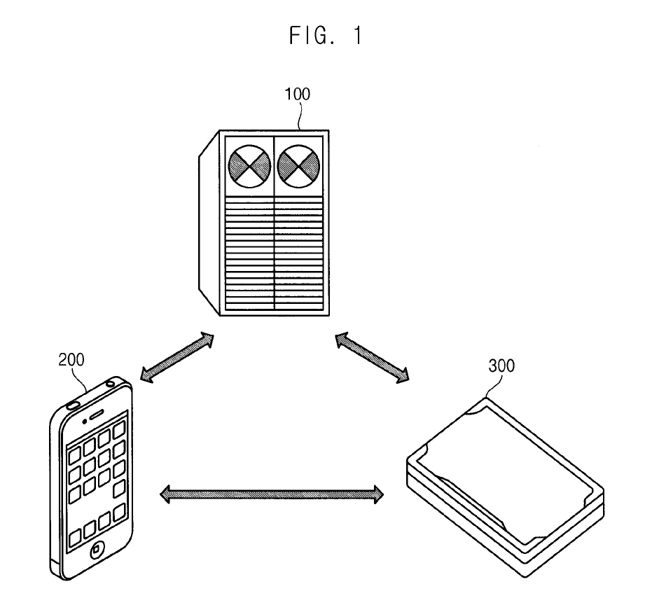

FIG. 1 is a diagram illustrating a system for protecting a core code of an application according to example embodiments.

Referring to FIG. 1, a system for protecting a core code of an application includes an application providing server 100, a user terminal 200, and a peripheral device 300.

As illustrated in FIG. 1, the application providing server 100, the user terminal 200, and the peripheral device 300 may be connected by a network. That is, the user terminal 200 may be connected to the application providing server 100 and the peripheral device 300 by a network, and the peripheral device 300 may be connected to the application providing server 100 by a network.

Here, the network represents a connection structure capable of communicating data among nodes such as user terminals, servers, etc. The network may include an internet, local area network (LAN), wireless LAN, wide area network (WAN), personal area network (PAN), 3G network, 4G network, Wi-Fi, etc.

In some example embodiments, the user terminal 200 and the peripheral device 300 may be coupled wirelessly by Bluetooth, ZigBee, infrared data association (IrDA), etc. In other example embodiments, the user terminal 200 and the peripheral device 300 may be coupled by a wire.

The application providing server 100 may distribute an application by transmitting a core code file of the application to the peripheral device 300 and transmitting a normal code file of the application to the user terminal 200.

The application providing server 100 according to example embodiments may store normal code files and core code files of various kinds of applications, such as a finance application, a news application, a shopping application, a game application, etc. The user terminal 200 and the peripheral device 300 may download and install the normal code file and the core code file of the application, respectively, from the application providing server 100. In some example embodiments, the application providing server 100 may correspond to a mobile application market. For example, the application providing server 100 may correspond to Google Play, App Store of Apple, a developer's server, etc.

The user terminal 200 may receive the normal code file of the application from the application providing server 100 and install the normal code file of the application in the user terminal 200. When the application is executed for the first time or a certification of a core code of the application is requested, the user terminal 200 may receive the core code file from the peripheral device 300, encrypt the core code file, and transmit the encrypted core code file to the peripheral device 300.

The user terminal 200 may correspond to any terminal that is able to install an application and execute the application. For example, the user terminal 200 may include a smart phone, a smart pad, a cellular phone, a laptop computer, a tablet computer, a personal digital assistant (PDA), etc.

Here, the application represents a program executable on a terminal. For example, the application may include an app that is executed on a mobile terminal such as a smart phone. The user may download the application from a mobile application market at which mobile contents are traded, and install the application on the user terminal 200.

When the application is executed again, the user terminal may receive the encrypted core code file from the peripheral device 300, decrypt the encrypted core code file, and execute the application using the decrypted core code file and the normal code file.

In some example embodiments, the peripheral device 300 may receive the core code file of the application from the application providing server 100 and store the core code file of the application. In other example embodiments, the core code file of the application may be the stored in the peripheral device 300 by a developer of the application.

The peripheral device 300 may transmit the core code file to the user terminal 200, and receive the encrypted core code file from the user terminal 200 and store the encrypted core code file. In addition, the peripheral device 300 may transmit the encrypted core code file to the user terminal when the application is executed on the user terminal 200.

The peripheral device 300 may correspond to any electronic device that is able to communicate with the user terminal 200 and the application providing server 100, and to receive and store the core code file of the application. For example, the peripheral device 300 may include a wearable device, such as a smart watch, a smart glasses, a smart band, etc., and a storage device having a communication function, such as an external hard disk drive (HDD), a universal serial bus (USB), an On-The-Go (OTG), etc.

In some example embodiments, the peripheral device 300 may include an appcessory, such as an activity tracker, a mobile photo printer, a home monitoring device, a toy, a medical device, etc. Here, appcessory represents an accessory that broadens functions of the user terminal 200 (e.g., smart phone) in association with an application.

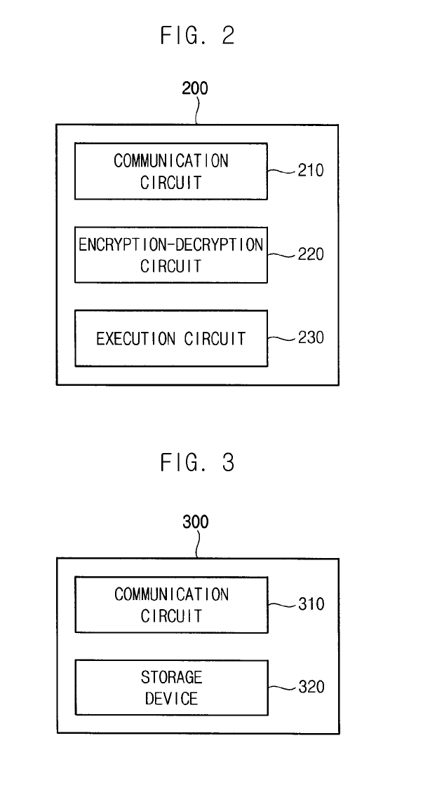

FIG. 2 is a block diagram illustrating a user terminal according to example embodiments.

Referring to FIG. 2, a user terminal 200 may include a communication circuit 210, an encryption-decryption circuit 220, and an execution circuit 230.

The communication circuit 210 may communicate with the application providing server 100 and the peripheral device 300. In some example embodiments, the communication circuit 210 may communicate with the application providing server 100 by a wireless communication scheme, such as Wi-Fi, 3G network, 4G network, long term evolution (LTE), Wibro, etc., and communicate with the peripheral device 300 by a wireless communication scheme, such as Bluetooth, ZigBee, infrared data association (IrDA), etc., or a wired communication scheme.

The communication circuit 210 may receive the normal code file of the application from the application providing server 100, and install the application on the user terminal 200.

The communication circuit 210 may communicate with the peripheral device 300 that stores the core code file of the application.

When the user terminal 200 receives a command from the user to execute the application for the first time or is requested to perform a certification of a core code of the application, the communication circuit 210 may receive the core code file from the peripheral device 300, which is paired with the user terminal 200, and transmit the encrypted core code file, which is encrypted by the encryption-decryption circuit 220, to the peripheral device 300.

When the application is executed again, the communication circuit 210 may transmit a message requesting the encrypted core code file to the peripheral device 300, and receive the encrypted core code file from the peripheral device 300.

The encryption-decryption circuit 220 may encrypt the core code file received from the peripheral device 300. When the application is executed again, the encryption-decryption circuit 220 may decrypt the encrypted core code file received from the peripheral device 300 to acquire the core code file of the application. In some example embodiments, the encryption-decryption circuit 220 may perform the encryption operation and the decryption operation using distinct information of the user terminal 200. The distinct information of the user terminal 200 may include at least one of an international mobile equipment identity (IMEI), an Android Identification (ANDROID_ID), a serial number, a phone number, a model number, and a media access control (MAC) address. However, example embodiments are not limited thereto.

The execution circuit 230 may execute the application using the normal code file of the application, which is stored in the user terminal 200, and the core code file, which is acquired by decrypting the encrypted core code file.

FIG. 3 is a block diagram illustrating a peripheral device according to example embodiments.

Referring to FIG. 3, a peripheral device 300 may include a communication circuit 310, and a storage device 320.

The communication circuit 310 may communicate with the application providing server 100 and the user terminal 200. During an application division and transmission stage, the communication circuit 310 may receive the core code file of the application from the application providing server 100.

When the application is executed on the user terminal 200 for the first time or a certification of the core code of the application is requested to the user terminal 200, the communication circuit 310 may transmit the core code file to the user terminal 200 and receive the encrypted core code file from the user terminal 200.

When the application is executed again on the user terminal 200, the communication circuit 310 may receive the message requesting the encrypted core code file from the user terminal 200, and transmit the encrypted core code file to the user terminal 200.

The storage device 320 may store the core code file, which is received from the application providing server 100 or from the developer of the application, and the encrypted core code file received from the user terminal 200.

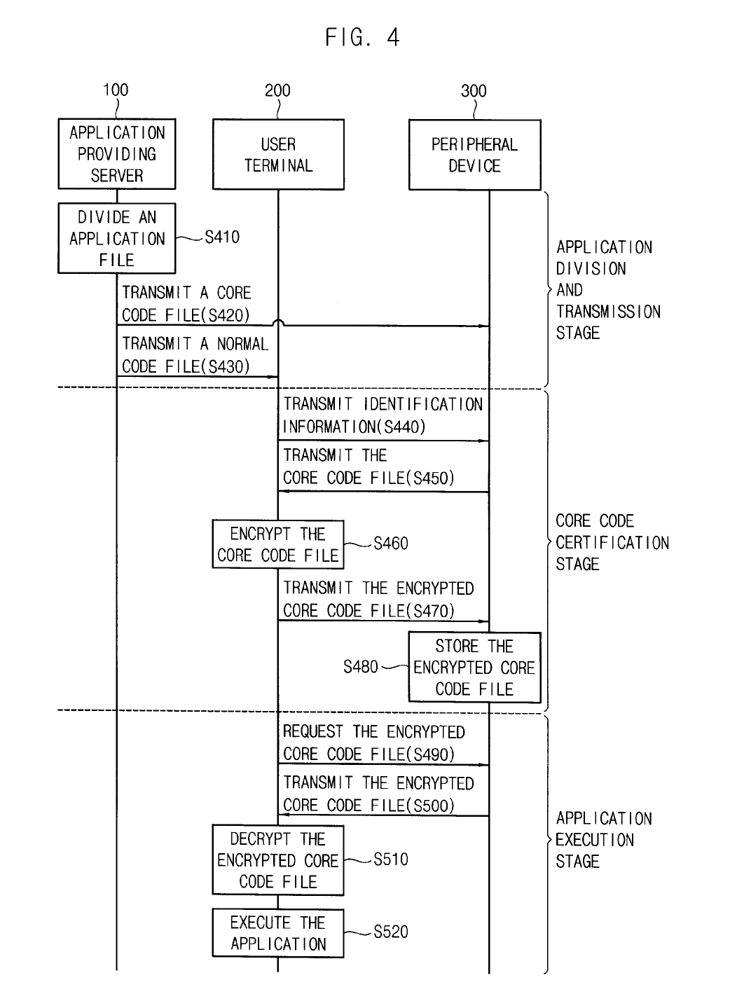

Hereinafter, a method for protecting a core code of an application according to example embodiments will be described with reference to FIG. 4.

FIG. 4 is a flow chart illustrating a method for protecting a core code of an application according to example embodiments.

In the method for protecting a core code of an application of FIG. 4, an application division and transmission stage may include steps S410 to S430, a core code certification stage may include steps S440 to S480, and an application execution stage may include steps S490 to S520.

At first, the application providing server 100 may perform the application division and transmission stage through the steps S410 to S430.

The application providing server 100 may divide an application file (step S410). For example, the application providing server 100 may define the core code using an execution file, which is generated by decompiling an application package, and generate the core code file based on the core code. After that, the application providing server 100 may generate the normal code file, which includes the normal code only, by deleting the core code from the application file.

The application providing server 100 may transmit the core code file to the peripheral device 300 (step S420). In some example embodiments, the application providing server 100 may transmit the core code file to the peripheral device 300 by a near field communication or a wired communication to increase a security level.

Although FIG. 4 illustrates that the application providing server 100 divides the application file and the peripheral device 300 receives the core code file of the application from the application providing server 100, example embodiment are not limited thereto. According to example embodiments, the developer of the application may store the core code of the application in the peripheral device 300, and then distribute the peripheral device 300.

When the user terminal 200 connects to the application providing server 100, the application providing server 100 may transmit the normal code file of the application to the user terminal 200 using a download scheme (step S430). The user terminal 200 may download the normal code file of the application through a network, such as 3G network, 4G network, Wi-Fi, etc., and installs the application using the normal code file.

After that, the user terminal 200 and the peripheral device 300 may perform a core code certification using the steps S440 to S480.

The user terminal 200 may perform a pairing operation with the peripheral device 300. In some example embodiments, the user terminal 200 may be paired with the peripheral device 300 during the core code certification stage. However, example embodiments are not limited thereto. According to example embodiments, the user terminal 200 may be paired with the peripheral device 300 before the core code certification stage.

The user terminal 200 may transmit identification information of the application to the peripheral device 300 (step S440). The peripheral device 300 may determine an application, which is requested by the user terminal 200, among a plurality of applications stored in the peripheral device 300 using the identification information.

The peripheral device 300 may transmit the core code file of the application, which corresponds to the identification information, to the user terminal 200 (step S450). In some example embodiments, the peripheral device 300 may transmit the core code file to the user terminal 200 by a near field communication or a wired communication to increase a security level.

The user terminal 200 may encrypt the core code file (step S460). The user terminal 200 may acquire the distinct information of the user terminal 200, and encrypt the core code file using the distinct information of the user terminal 200. The distinct information of the user terminal 200 may include at least one of an international mobile equipment identity (IMEI), an Android Identification (ANDROID_ID), a serial number, a phone number, a model number, and a media access control (MAC) address. However, example embodiments are not limited thereto.

The international mobile equipment identity (IMEI) is a distinct identification number that is assigned to each of cellular phones. According to a guideline of a global system for mobile communications association (GSMA), every producers of cellular phones assign the international mobile equipment identity (IMEI) to each of the cellular phones. The international mobile equipment identity (IMEI) includes 15 digits (8 digits of an approval code, 6 digits of a model serial number, and a check digit), and is used for stopping a stolen phone from accessing a network.

In the system for protecting a core code of an application according to example embodiments, the user terminal 200 may use an Android Identification (ANDROID_ID), which is generated when the user terminal 200 boots up for the first time and has 64 digits, a serial number, which is assigned to the user terminal 200 when the user terminal 200 is produced, a model number of the user terminal 200, and a phone number of the user terminal 200 as the distinct information of the user terminal 200. In addition, a media access control (MAC) address of the user terminal 200, which uses Wi-Fi or Bluetooth, may be used as the distinct information of the user terminal 200.

That is, the terminal 200 may encrypt the core code file using the distinct information of the user terminal 200, and decrypt the encrypted core code file using the distinct information of the user terminal 200.

The user terminal 200 may transmit the encrypted core code file to the peripheral device 300 (step S470), and the peripheral device 300 may store the encrypted core code file (step S480).

The encrypted core code file, which is encrypted using the distinct information of the user terminal 200, may be subordinated to the user terminal 200. That is, the encrypted core code file may be decrypted by only the user terminal 200, which generated the encrypted core code file. Other user terminal may not be able to decrypt the encrypted core code file although the other user terminal acquires the encrypted core code file from the peripheral device 300.

When the application is executed on the user terminal 200, the user terminal 200 and the peripheral device 300 may perform the application execution stage using the steps S490 to S520. Before the step S490, the user terminal 200 may determine whether the peripheral device 300, which stores the core code file of the application, is near the user terminal 200.

The user terminal 200 may transmit the message requesting the encrypted core code file to the peripheral device 300 (step S490). In some example embodiments, the message may include the identification information of the application.

The peripheral device 300 may transmit the encrypted core code file of the application, which is stored in the peripheral device 300 during the step S480, to the user terminal 200 (step S500).

The user terminal 200 decrypt the encrypted core code file using the distinct information of the user terminal 200 (step S510).

The user terminal 200 may execute the application by combining the decrypted core code file and the normal code file stored in the user terminal 200 (step S520).

The normal code file stored in the user terminal 200 may correspond to a main routine, and the core code file stored in the peripheral device 300 may correspond to a sub routine. When the user terminal 200 executes the normal code file, the normal code file may call the sub routine to execute the core code file, which is decrypted during the step S510. As such, the application may be executed on the user terminal 200.

As described above, since the normal code file is stored in the user terminal 200 and the core code file is stored in the peripheral device 300, which is able to communicate with the user terminal 200, the core code of the application may be protected from reverse engineering attacks.

In addition, the user terminal 200 may encrypt the core code file using the distinct information of the user terminal 200, and the peripheral device 300 may store the encrypted core code file. Therefore, although one of the user terminal 200 and the peripheral device 300 is stolen, the acquirer may not be able to execute the application. As such, an illegal use of the application may be effectively prevented.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### REFERENCE NUMERALS

100: application providing server
200: user terminal
210: communication circuit
220: encryption-decryption circuit
230: execution circuit
300: peripheral device
310: communication circuit
320: storage device

What is claimed is:

1. A user terminal for protecting a core code of an application, comprising:
a communication circuit configured to receive a core code file of the application from a peripheral device, which stores the core code file of the application, when certifying the core code of the application;
an encryption-decryption circuit configured to encrypt the core code file and transmit the encrypted core code file to the peripheral device, and, when executing the application, to receive the encrypted core code file from the peripheral device and decrypt the encrypted core code file; and
an execution circuit configured to execute the application using the decrypted core code file and a normal code file of the application stored in the user terminal.

2. The user terminal of claim 1, wherein the encryption-decryption circuit encrypts the core code file using distinct information of the user terminal and decrypts the encrypted core code file using the distinct information of the user terminal, and
the distinct information of the user terminal includes at least one of an international mobile equipment identity (IMEI), an Android Identification (ANDROID_ID), a serial number, a phone number, a model number, and a media access control (MAC) address.

3. The user terminal of claim 1, wherein the peripheral device receives the core code file from an application providing server and stores the core code file, and
the application providing server generates the core code file and the normal code file by dividing an installation file of the application into the core code and a normal code, transmits the core code file to the peripheral device, and transmits the normal code file to the user terminal.

4. The user terminal of claim 1, wherein the core code file is selected by at least one of a user and a function or an object predetermined by a platform of the application providing server.

5. A method for protecting a core code of an application installed in a user terminal, comprising:
receiving, by the user terminal, a core code file of the application from a peripheral device, which stores the core code file of the application, when certifying the core code of the application;
encrypting the core code file to transmit the encrypted core code file to the peripheral device;
receiving, when executing the application, the encrypted core code file from the peripheral device to decrypt the encrypted core code file; and
executing the application using the decrypted core code file and a normal code file of the application stored in the user terminal.

6. The method of claim 5, wherein the user terminal encrypts the core code file using distinct information of the user terminal and decrypts the encrypted core code file using the distinct information of the user terminal, and
the distinct information of the user terminal includes at least one of an international mobile equipment identity (IMEI), an Android Identification (ANDROID_ID), a serial number, a phone number, a model number, and a media access control (MAC) address.

7. The method of claim 5, wherein the peripheral device receives the core code file from an application providing server and stores the core code file, and
the application providing server generates the core code file and the normal code file by dividing an installation file of the application into the core code and a normal code, transmits the core code file to the peripheral device, and transmits the normal code file to the user terminal.

8. The method of claim 5, wherein the core code file is selected by at least one of a user and a function or an object predetermined by a platform of the application providing server.
